(19) United States
(12) Patent Application Publication
(10) Pub. No.: US 2014/0006449 A1
(43) Pub. Date: Jan. 2, 2014

(54) SYSTEM FOR INTEROPERATING DHT-BASED OVERLAY NETWORKS AND METHOD THEREOF

(71) Applicant: Electronics and Telecommunications Research Institute, Daejeon (KR)

(72) Inventors: Byung Joon LEE, Daejeon (KR); Hong Seok Jeon, Daejeon (KR)

(21) Appl. No.: 13/912,150

(22) Filed: Jun. 6, 2013

(30) Foreign Application Priority Data
Jun. 29, 2012 (KR) 10-2012-0070767

(51) Int. Cl. G06F 17/30

(52) U.S. Cl. CPC G06F 17/30091
USPC 707/781

(57) ABSTRACT

Disclosed are a system for interoperating DHT-based overlay networks and a method thereof. The system for interoperating DHT-based overlay networks includes a domain participation node inquiring an address of a node in which a file is stored in a predetermined domain management node when there is no node storing a file to be used in a unit overlay network which the domain participation node itself belongs to; and a domain management node providing the address of the node storing the file by interoperating at least one different unit overlay network in accordance with the inquiry of the domain participation node.

### CROSS-REFERENCE TO RELATED APPLICATIONS

This application claims priority to and the benefit of Korean Patent Application No. 10-2012-0070767 filed in the Korean Intellectual Property Office on Jun. 29, 2012, the entire contents of which are incorporated herein by reference.

### TECHNICAL FIELD

The present invention relates to a method for interoperating overlay networks, and particularly, to a system for interoperating DHT-based overlay networks that is configured to set a domain management node for each unit overlay network configured based on a DHT and interoperate different unit overlay networks through the set domain management node, and a method thereof.

### BACKGROUND

A distributed hash table (DHT) refers to a technology that distributes and stores a hash table configured by a pair of a key and a value to a plurality of nodes on the Internet. The DHT technology is primarily used in an overlay network technology such as peer to peer (P2P).

The DHT technology solves a scalability problem of a distribution index by easily distributing and storing positional information of a sharing target file. However, the DHT technology has a problem in that positional information of a node which participates in a network is not considered.

For example, it is assumed that nodes positioned in Seoul and nodes positioned in Busan are connected to each other through the DHT. It is assumed that a user who is positioned in Seoul intends to download a file A through the corresponding DHT. It is assumed that the file A is stored in one of the nodes positioned in Seoul. Since the user does not know the position of A, the user first needs to inquire the position of A of the DHT in order to download A. However, the positional information of the file A may be stored in the node positioned not in Seoul but in Busan due to a feature of the DHT. Therefore, the user inquires the position of A of the node positioned in Busan and receives the result and thereafter, needs to request A to the Seoul node with A, in order to use the file A.

Therefore, a transmission path of an inquiry packet sent to use one content may be significantly lengthened, and as a result, unnecessary long-distance traffics may occur. The feature of the DHT makes it difficult to interoperate two overlay networks using the DHT. At the moment of connecting two overlay networks, DHTs of two networks become one and the aforementioned problem becomes more serious.

### SUMMARY

The present invention has been made in an effort to provide a system for interoperating DHT-based overlay networks that is configured to set a domain management node for each unit overlay network configured based on DHT and interoperate different unit overlay networks through the set domain management node, and a method thereof.

An exemplary embodiment of the present invention provides a system for interoperating unit overlay networks including: a domain participation node inquiring an address of a node in which a file is stored in a predetermined domain management node when there is no node storing a file to be used in a unit overlay network which the domain participation node itself belongs to; and a domain management node providing the address of the node storing the file by interoperating at least one different unit overlay network in accordance with the inquiry of the domain participation node.

The domain participation node may calculate a key value of the file to be used and calculate an address of a predetermined node by using the calculated key value and thereafter, inquire an address of the node in which the file is stored in the node at the calculated address, and inquire an address of a node in which a file is stored in a predetermined domain management node when there is no node storing a file to be used in a unit overlay network which the domain participation node itself belongs to as a result of the inquiry.

The domain participation node may calculate the calculated key value of the file to be used by using a hashing function.

The domain participation node may calculate DHT(K) which is an address of a predetermined node by using a calculated key value K of the file to be used.

The domain participation node may calculate an address of the domain participation node, DHT(M) storing the address of the domain management node by using a key value M of a predetermined domain management node, verify the address of the domain management node by inquiring of the domain participation node by means of the calculated address, and inquire the verified address of the node in which the file is stored in the domain management node.

The domain participation node may connect a communication channel to an address of a node storing a file received from a domain management node to download the corresponding file through the connected communication channel.

The domain participation node may calculate a key value for a file stored therein and calculate an address of a predetermined node by using the calculated key value and thereafter, store the calculated key value and its own address in the node at the calculated address.

The domain management node may calculate an address of a predetermined node by using a predetermined key value and store its own address in the node at the calculated address.

Another exemplary embodiment of the present invention provides a method for interoperating unit overlay networks, including: verifying whether a node storing a file to be used is present in a unit overlay network which the node belongs to; inquiring an address of a node in which a file is stored in a predetermined domain management node when there is no node storing the file as a result of the verification; and connecting a communication channel to an address of a node storing a file received from the domain management node to download the corresponding file through the connected communication channel.

In the verifying, a key value of the file to be used may be calculated and an address of a predetermined node may be calculated by using the calculated key value and thereafter, an address of the node storing the file may be inquired of the node at the calculated address.

In the verifying, the calculated key value of the file to be used may be calculated by using a hashing function.

In the verifying, DHT(K) which is an address of a predetermined node is calculated by using a calculated key value K of the file to be used.

The address may be an Internet protocol (IP) address.

In the inquiring, an address of the domain participation node, DHT(M) storing the address of the domain management node may be calculated by using a key value M of a predetermined domain management node, the address of the domain management node may be verified by inquiring of the domain participation node by means of the calculated address, and the address of the node storing the file may be inquired of the verified domain management node.

The method may further include calculating a key value for a file stored therein and calculating an IP address of a predetermined node by using the calculated key value and thereafter, storing the calculated key value and its own address in the node at the calculated address.

According to the exemplary embodiments of the present invention, a domain management node is set for each unit overlay network configured based on DHT and different unit overlay networks are interoperated through the set domain management node to prevent a packet from being unnecessarily transmitted to another domain.

According to the exemplary embodiments of the present invention, the domain management node is set for each unit overlay network configured based on the DHT and different unit overlay networks are interoperated through the set domain management node to efficiently access a file.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a diagram illustrating a system for interoperating DHT-based overlay networks according to an exemplary embodiment of the present invention.

FIG. 2 is a diagram illustrating a method for interoperating unit overlay networks according to an exemplary embodiment of the present invention.

FIG. 3 is a first diagram for describing an operating principle to interoperate unit overlay networks according to an exemplary embodiment of the present invention.

FIG. 4 is a second diagram for describing an operating principle to interoperate unit overlay networks according to an exemplary embodiment of the present invention.

FIG. 5 is a third diagram for describing an operating principle to interoperate unit overlay networks according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, exemplary embodiments of the present invention will be described in detail with reference to the accompanying drawings.

In particular, the present invention discusses a new method for interoperating overlay networks that is configured to set the domain management node for each unit overlay network configured based on the DHT and interoperate different unit overlay networks through the set domain management node.

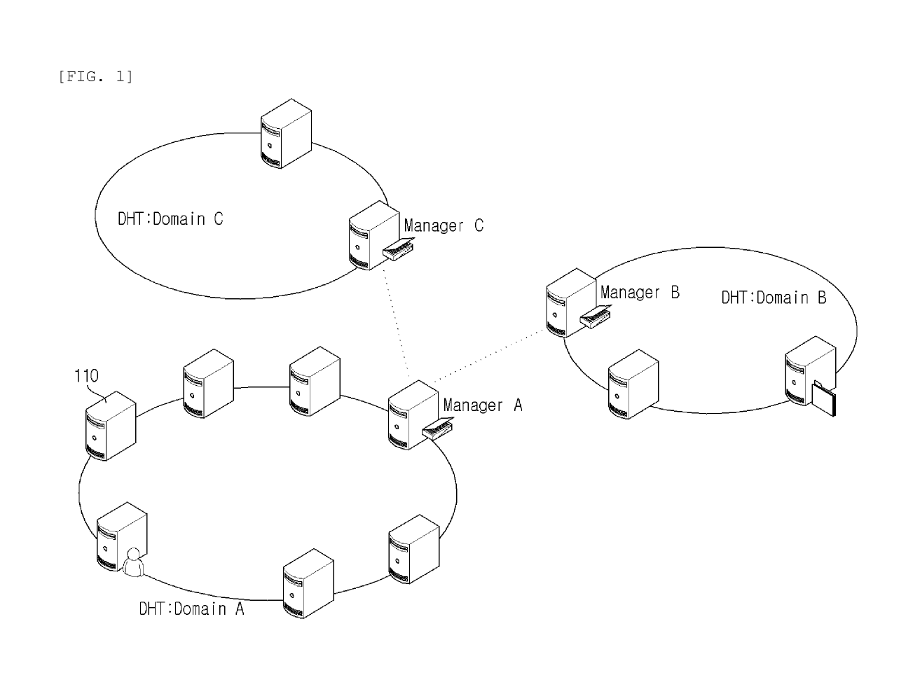

FIG. 1 is a diagram illustrating a system for interoperating DHT-based unit overlay networks according to an exemplary embodiment of the present invention.

As illustrated in FIG. 1, the system for interoperating DHT-based unit overlay networks according to the exemplary embodiment of the present invention may include a plurality of unit overlay networks each of which is constituted by a plurality of domain participation nodes 110 and a domain management node 120.

The domain participation node 110 as a node configuring the DHT-based unit overlay network may share an internode file or content by using a distributed hash table (DHT) function.

The domain participation node 110 may share the content among all nodes constituting the unit overlay networks of the same domain by using the DHT function and share the content among all nodes constituting unit overlay networks of different domains.

In this case, a principle to use the DHT function will be described below in detail. The DHT function described herein is a simple type of DHT function on the assumption that each node on the network knows IP addresses of all the other nodes, and there are a lot of DHT functions which do not need the assumption, but operating principles are substantially similar. For example, DHT(K) is a function that returns an IP address of a node that will manage a value V mapped to a key called K. To this end, respective nodes that participate in the DHT-based overlay networks need to know IP addresses of all nodes. The respective nodes constructs a virtual topology required to calculate DHT(K) by using the IP addresses.

The virtual topology stores and constructs the IP address of each node on a circular hash space H. That is, when N IP addresses of IP1, IP2, IP3, . . . , IPn exist in one DHT network, the respective IP addresses are stored in respective points of H(IP1), H(IP2), H(IP3), . . . , H(IPn).

In this state, DHT(K) may be calculated as follows. H(K) is acquired. This value is positioned at a predetermined point on the hash space H. An IP address which is first met while circumambulating the hash space H counterclockwise from the point is a value of DHT(K).

1) When intending to store the file, all of the nodes on the DHT-based networks calculate key values K of files which the nodes intend to store and may calculate DHT(K), that is, the IP address by using the calculated key values. The node transmits a message including the IP address of K to a node at the calculated IP address and the node that receives the message stores the corresponding message.

In this case, the key value of the file may be calculated by using various algorithms and may be a hash function.

Therefore, all of the nodes on the DHT-based networks may distribute and store the key value of the file and an address of a node storing a file corresponding to the key value, that is, an IP address.

2) When intending to use the file, all of the nodes on the DHT-based networks calculate key values K of files and may calculate DHT(K), that is, the IP address by using the calculated key values. The key value K may be acquired through an external system when the key value K of the file may not be calculated. As the external system, a search engine such as Google or Tracker Server widely used in the P2P technology may be used. The node transmits a message to inquire an IP address of a node storing the file of the node at the calculated IP address and receives the IP address of the node storing the file as a response thereof.

Therefore, the node connects one communication channel to the node at the IP address storing the received file and may download the corresponding file through the connected communication channel.

The domain management node 120 serves to interoperate the unit overlay networks and may be interoperated with a domain management node of another unit overlay network.

In this case, the domain management node 120 calculates DHT (DOMAIN_MANAGER) by using a predetermined key value DOMAIN_MANAGER and stores its own address in a node indicated by an address acquired by a calculation result.

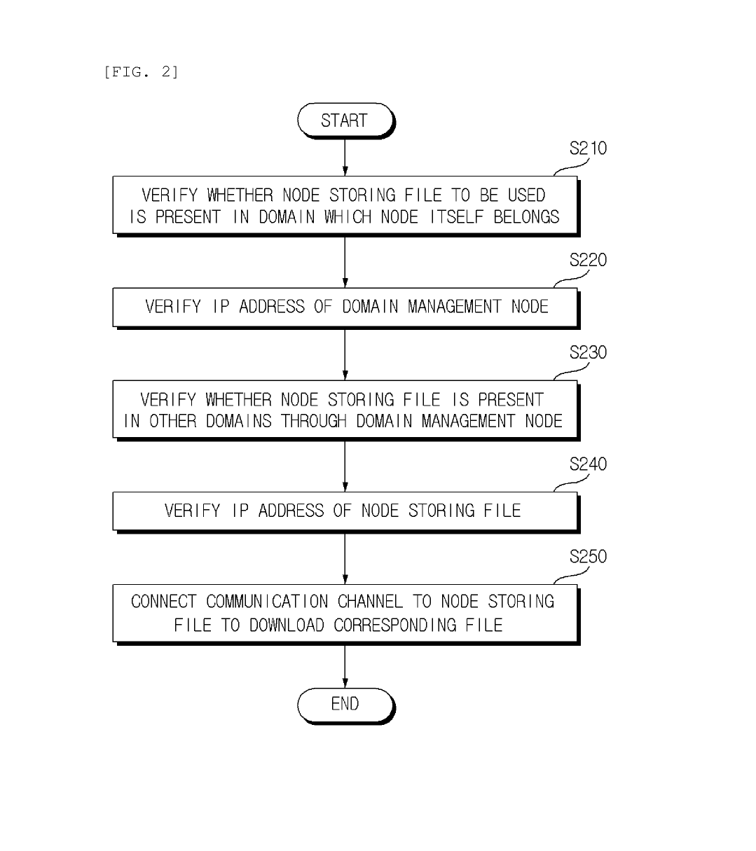

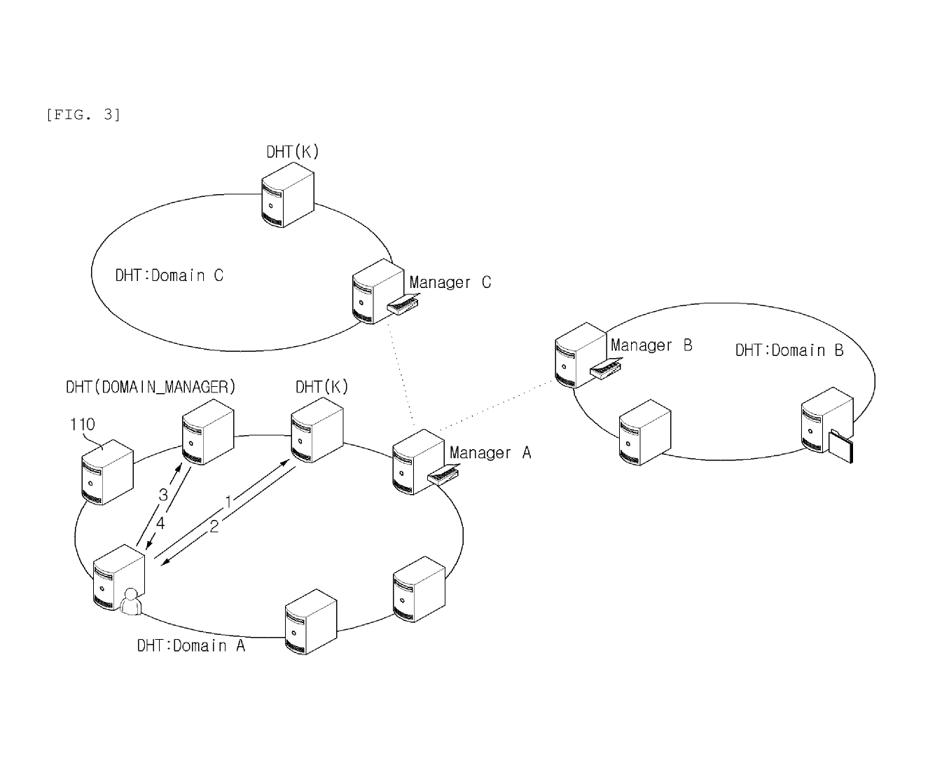

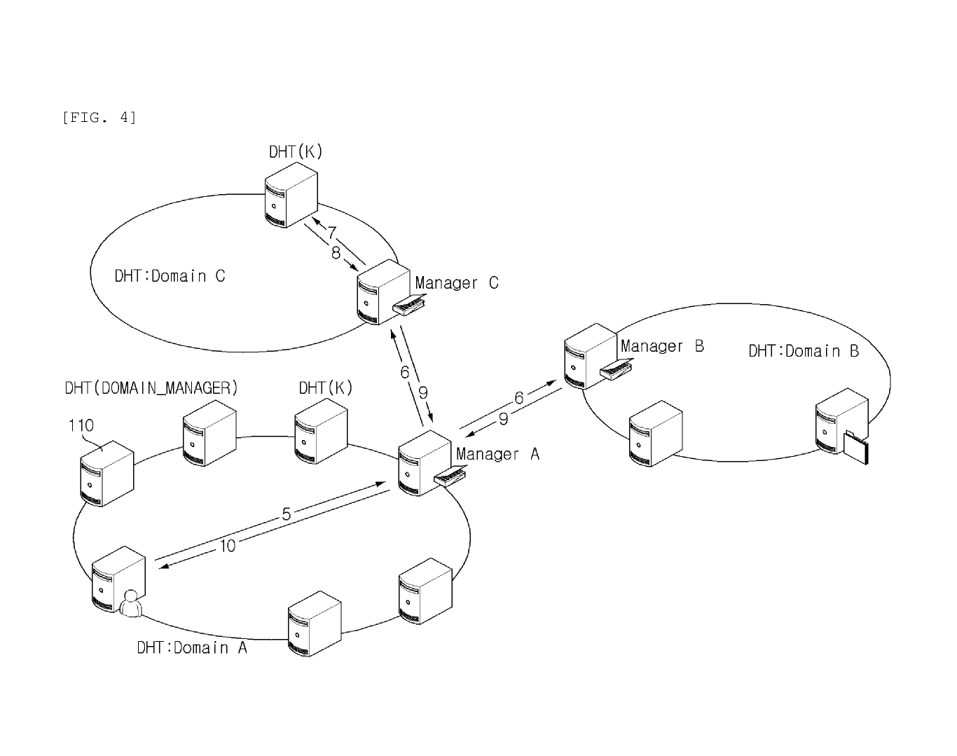

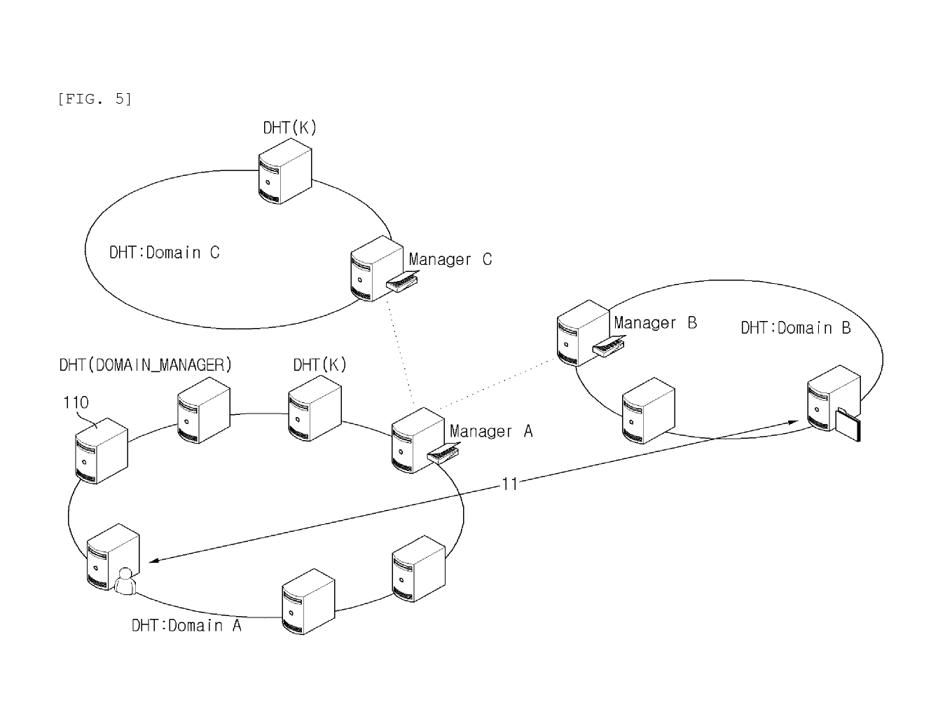

FIG. 2 is a diagram illustrating a method for interoperating unit overlay networks according to an exemplary embodiment of the present invention. FIG. 3 is a first diagram for describing an operating principle to interoperate unit overlay networks according to an exemplary embodiment of the present invention. FIG. 4 is a second diagram for describing an operating principle to interoperate unit overlay networks according to an exemplary embodiment of the present invention. FIG. 5 is a third diagram for describing an operating principle to interoperate unit overlay networks according to an exemplary embodiment of the present invention.

Referring to FIGS. 2 to 5, first, a domain participation node may verify whether a node storing a file to be used is present in a domain which the domain participation node belongs to (S210). That is, a domain participation node of a domain A calculates a key value K of the file to be used and may calculate DHT(K), that is, an IP address of a predetermined node by using the calculated key value.

The domain participation node, as illustrated in FIG. 3, may transmit an inquiry message to inquire an IP address of a node storing a file to the node DHT(K) and receive a response message including an IP address of the node storing the file as a response to the transmitted inquiry message from the node DHT(K).

The domain participation node may verify whether the IP address of the node storing the file included in the response message is present.

Next, since the domain participation node judges that the IP address of the node storing the file is not known when the IP address of the node storing the file is not present as a result of the verification, the domain participation node may verify an IP address of a domain management node (S220). That is, the domain participation node may calculate DHT (DOMAIN_MANAGER), that is, an IP address of a predetermined node by using a key value DOMAIN_MANAGER of a predetermined domain management node.

Next, the domain participation node, as illustrated in FIG. 3, may transmit an inquiry message to inquire the IP address of the domain management node to the node DHT (DOMAIN_MANAGER) and receive a response message including the IP address of the domain management node as a response to the transmitted inquiry message from the node DHT (DOMAIN_MANAGER).

Next, the domain participation node may verify whether a node storing the file is present in another domain through the domain management node (S230). That is, the domain participation node may transmit an inquiry message to inquire the IP address of the node storing the file to a domain management node MANAGER A of the IP address included in the response message as illustrated in FIG. 4.

When the domain management node receives the inquiry message as illustrated in FIG. 4, the domain management node may transfer the received inquiry message to respective domain management nodes MANAGER B and MANAGER C in another domain.

In this case, the respective domain management nodes MANAGER B and MANAGER C transfer the inquiry message to nodes which are present in their own domains DOMAIN B and DOMAIN C to inquire an IP address of a corresponding file.

The domain management node may receive the response message from the respective domain management nodes MANAGER B and MANAGER C of another domain as the response to the inquiry message and transfer the received response message to a domain participation node which intends to use the file as illustrated in FIG. 4.

Next, the domain management node may verify the IP address of the node storing the file included in the received response message (S240).

Next, the domain management node connects the communication channel to the node at the IP address included in the response message to download the corresponding file through the connected communication channel as illustrated in FIG. 5 (S250).

Meanwhile, the embodiments according to the present invention may be implemented in the form of program instructions that can be executed by computers, and may be recorded in computer readable media. The computer readable media may include program instructions, a data file, a data structure, or a combination thereof. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A system for interoperating unit overlay networks, the system comprising:
a domain participation node inquiring an address of a node in which a file is stored in a predetermined domain management node when there is no node storing a file to be used in a unit overlay network which the domain participation node itself belongs to ; and
a domain management node providing the address of the node storing the file by interoperating at least one different unit overlay network in accordance with the inquiry of the domain participation node.

2. The system of claim 1, wherein the domain participation node calculates a key value of the file to be used and calculates an address of a predetermined node by using the calculated key value and thereafter, inquires an address of the node in which the file is stored in the node at the calculated address, and inquires an address of a node in which a file is stored at a predetermined domain management node when there is no node storing a file to be used in a unit overlay network which the domain participation node itself belongs to as a result of the inquiry.

3. The system of claim 2, wherein the domain participation node calculates the calculated key value of the file to be used by using a hashing function.

4. The system of claim 2, wherein the domain participation node calculates DHT(K) which is an address of a predetermined node by using a calculated key value K of the file to be used.

5. The system of claim 1, wherein the domain participation node calculates an address of the domain participation node, DHT(M) storing the address of the domain management node by using a key value M of a predetermined domain management node, verifies the address of the domain management node by inquiring of the domain participation node by means of the calculated address, and inquires the verified address of the node in which the file is stored in the domain management node.

6. The system of claim 1, wherein the domain participation node connects a communication channel to an address of a node storing a file received from a domain management node to download the corresponding file through the connected communication channel.

7. The system of claim 1, wherein the domain participation node calculates a key value for a file stored therein and calculates an address of a predetermined node by using the calculated key value and thereafter, stores the calculated key value and its own address in the node at the calculated address.

8. The system of claim 1, wherein the domain management node calculates an address of a predetermined node by using a predetermined key value and stores its own address in the node at the calculated address.

9. A method for interoperating unit overlay networks, the method comprising:
verifying whether a node storing a file to be used is present in a unit overlay network which the node itself belongs to;
inquiring an address of a node in which a file is stored in a predetermined domain management node when there is no node storing the file as a result of the verification; and
connecting a communication channel to an address of a node storing a file received from the domain management node to download the corresponding file through the connected communication channel.

10. The method of claim 9, wherein in the verifying, a key value of the file to be used is calculated and an address of a predetermined node is calculated by using the calculated key value and thereafter, an address of the node storing the file is inquired of the node at the calculated address.

11. The method of claim 10, wherein in the verifying, the calculated key value of the file to be used is calculated by using a hashing function.

12. The method of claim 10, wherein in the verifying, DHT(K) which is an address of a predetermined node is calculated by using a calculated key value K of the file to be used.

13. The method of claim 9, wherein the address is an Internet protocol (IP) address.

14. The method of claim 9, wherein in the inquiring, an address of the domain participation node, DHT(M) storing the address of the domain management node is calculated by using a key value M of a predetermined domain management node, the address of the domain management node is verified by inquiring of the domain participation node by means of the calculated address, and the address of the node storing the file is inquired of the verified domain management node.

15. The method of claim 9, further comprising:
calculating a key value for a file stored therein and calculating an IP address of a predetermined node by using the calculated key value and thereafter, storing the calculated key value and its own address in the node at the calculated address.
